(19) United States
(12) Patent Application Publication
(10) Pub. No.: US 2025/0046096 A1
(43) Pub. Date: Feb. 6, 2025

(54) METHOD FOR DETECTING OBSTACLES

(71) Applicant: SAFRAN ELECTRONICS & DEFENSE, PARIS (FR)

(72) Inventors: Thomas CLEON, MOISSY-CRAMAYEL (FR); Joël BUDIN, MOISSY-CRAMAYEL (FR)

(21) Appl. No.: 18/696,223

(22) PCT Filed: Sep. 28, 2022
(86) PCT No.: PCT/EP2022/077017

§ 371 Date: Mar. 27, 2024

(30) Foreign Application Priority Data
Sep. 28, 2021 (FR) FR2110221

(51) Int. Cl. G06V 20/58; G06T 5/80; G06T 7/10

(52) U.S. Cl. CPC G06V 20/58; G06T 5/80; G06T 7/10

(57) ABSTRACT

A method for detecting obstacles includes implementing a semantic segmentation algorithm to produce a first segmented image from a first raw left or right image; rectifying the raw stereo images to obtain rectified stereo images, and the first segmented image to obtain a first rectified segmented image; producing a disparity map; producing a second rectified segmented image; producing a list of predefined instances of obstacles present in the vehicle's environment from the rectified segmented stereo images; and integrating the predefined instances of obstacles into intermediate images obtained from the rectified stereo images.

The invention relates to the field of detecting obstacles to provide assistance to the piloting of a vehicle or of a robot.

### BACKGROUND OF THE INVENTION

Today, there is a large number of obstacle-detection systems, which are intended to provide assistance to piloting different types of vehicles: flying, land vehicles, with or without a pilot onboard, autonomous vehicles, robots, etc.

Such an obstacle-detection system, in particular, has the aim of reducing collision accidents as much as possible, by providing to the pilot or to the navigation system of the vehicle, a certain amount of information relating to obstacles present in the vehicle's environment: position of the obstacles, distance between each obstacle and the vehicle, size and type of the obstacles, etc. The obstacles are, for example, electric cables, pylons, trees, etc.

Thus, obstacle-detection systems are known, which use RADAR (RAdar Detection And Ranging) technology or LIDAR (LIght Detection And Ranging) technology.

These systems have the disadvantage of emitting electromagnetic waves or light waves which make the vehicle easily detectable. Yet, in certain applications, in particular military, it is preferable that the vehicle equipped with the obstacle-detection system is difficult to detect (stealth vehicle).

Also, systems are known, which use the capture and the processing of images to detect and identify the obstacles.

For example, a passive obstacle-detection system called PODS (Passive Obstacle Detection System) is known, which is developed by Boeing. This system is capable of processing a significant image flow and operates with images captured in visible ranges, MWIR (Mid-Wave InfraRed) ranges or LWIR (Long-Wave InfraRed) ranges, or with images produced by PMMW (Passive MilliMeter Wave) sensors.

However, this system is capable of detecting only obstacles of the cable type, and only seems to operate with small-field sensors.

Also, systems are known, which detect obstacles thanks to StereoVision. Certain systems thus use UV mapping, but are not very accurate and are incapable of making the difference between the different types of obstacles.

Other systems also use satellite images, but are not designed to be embedded in vehicles such as a helicopter or a drone.

### AIM OF THE INVENTION

The invention aims to accurately and reliably detect and identify different types of obstacles, without emitting electromagnetic or light waves, to provide help for piloting any type of vehicle.

### SUMMARY OF THE INVENTION

In view of achieving this aim, a method for detecting obstacles is proposed, implemented in at least one processing unit, and comprising the steps of:
acquiring raw stereo images, representative of an environment of a vehicle and produced by stereo cameras, the raw stereo images comprising a raw left image and a raw right image;
implementing a semantic segmentation algorithm to produce a first segmented image from a first raw image, the first raw image being the raw left image or the raw right image;
rectifying the raw stereo images to obtain rectified stereo images, and the first segmented image to obtain a first rectified segmented image;
   implementing a disparity calculation algorithm between the rectified stereo images, to produce a disparity map;
implementing a spatial transformation of the first rectified segmented image, by using the disparity map, to produce a second rectified segmented image, corresponding to the side opposite that of the first raw image, and thus produce rectified segmented stereo images;
producing a list of predefined instances of obstacles present in the vehicle's environment from rectified segmented stereo images;
   implementing a three-dimension reconstruction algorithm, using the disparity map, to produce three-dimensional coordinates for each pixel of the raw stereo images;
   integrating, by using the three-dimensional coordinates, the predefined instances of obstacles in intermediate image obtained from rectified stereo images, to produce augmented images intended to provide assistance to the piloting of the vehicle.

The method for detecting obstacles according to the invention makes it possible to detect and differentiate the obstacles, accurately and reliably. The method for detecting obstacles according to the invention can provide assistance to the piloting of any type of vehicle and does not require the emission of electromagnetic or light waves. The augmented images can, for example, be projected onto the visor of the headset of a pilot.

In addition, a method for detecting obstacles such as described above is proposed, wherein the rectification step comprises a distortion correction and uses first parameters comprising extrinsic and intrinsic parameters of stereo cameras.

In addition, a method for detecting obstacles such as described above is proposed, wherein epipolar lines of the rectified stereo images and of the rectified segmented stereo images are horizontal.

In addition, a method for detecting obstacles such as described above is proposed, further comprising the step, preceding the implementation of the disparity calculation algorithm, to project the rectified stereo images into a system associated with a headset of a pilot of the vehicle.

In addition, a method for detecting obstacles such as described above is proposed, wherein the three-dimensional reconstruction algorithm uses second parameters comprising extrinsic and intrinsic parameters of stereo cameras, as well as navigation data produced by navigation sensors of an inertial measuring unit of the vehicle.

In addition, a method for detecting obstacles such as described above is proposed, wherein the three-dimensional coordinates of the reconstructed pixels are defined in a local geographic system associated with the vehicle and yaw-corrected.

In addition, a method for detecting obstacles such as described above is proposed, further comprising the step, preceding the implementation of the reconstruction algorithm, to verify a validity of a disparity value of each pair of homologous pixels comprising a left pixel of a left image and a right pixel of a right image.

In addition, a method for detecting obstacles such as described above is proposed, wherein the verification of the validity of the disparity of the pair of homologous pixels comprises the step of verifying that:

disp_{g}(x_{g},y)=disp_{d}(x_{g}−disp_{g}(x_{g},y),y) and

disp_{d}(x_{d},y)=disp_{g}(x_{d}+disp_{d}(x_{d},y),y)

disp_{g} being an estimated disparity by taking the left image as reference, disp_{d} being an estimated disparity by taking the right image as reference, x_{g} being a coordinate of the left pixel and x_{d} being a coordinate of the right pixel.

In addition, a method for detecting obstacles such as described above is proposed, wherein the verification of the validity of the disparity of the pair of homologous pixels comprises the step of implementing a post-accumulation mechanism by projecting disparity images passed over a current disparity image.

In addition, a method for detecting obstacles such as described above is proposed, comprising the step of determining that a group of pixels of a rectified segmented stereo image forms a predefined obstacle instance when said pixels are connected together.

In addition, a method for detecting obstacles such as described above is proposed, wherein two pixels are connected together, if one of the two pixels belongs to the vicinity of the other, and if the two pixels belong to one same class.

In addition, a method for detecting obstacles such as described above is proposed, wherein the integration step comprises the steps, for each predefined obstacle instance, of determining, by using predefined obstacle instance coordinates and the three-dimensional coordinates of the reconstructed pixels, a distance between said predefined obstacle instance and the vehicle, as well as dimensions of said predefined obstacle instance.

In addition, a method for detecting obstacles such as described above is proposed, wherein the intermediate images are rectified stereo images.

In addition, a method for detecting obstacles such as described above is proposed, wherein the integration step comprises, for each predefined obstacle instance, the step of inlaying a cross on a barycentre of said predefined obstacle instance.

In addition, a method for detecting obstacles such as described above is proposed, wherein the semantic segmentation algorithm uses a U-Net, HRNet, or HRNet+OCR neural network.

In addition, a method for detecting obstacles such as described above is proposed, wherein the stereo cameras are infrared cameras.

In addition, a system comprising stereo cameras and a processing unit are proposed, wherein the method for detecting obstacles such as described above is implemented.

In addition, a vehicle comprising a system such as described above is proposed.

In addition, a computer program comprising instructions which make the processing unit of the system such as described above execute the steps of the method for detecting obstacles such as described above is proposed.

In addition, a recording medium which can be read by a computer, on which the computer program is recorded such as described above is proposed.

The invention will be best understood in the light of the description below of a particular, non-limiting embodiment of the invention.

### BRIEF DESCRIPTION OF THE DRAWINGS

Reference will be made to the accompanying drawings, among which:

FIG. 1 schematically represents different modules of a helicopter, wherein the invention is implemented;

FIG. 2 represents steps of the method for detecting obstacles according to the invention;

FIG. 3 represents the implementation of the semantic segmentation algorithm;

FIG. 4 represents a U-Net neural network;

FIG. 5 represents an HRNet neural network;

FIG. 6 represents stereo images and makes it possible to illustrate the verification of disparity;

FIG. 7 represents an object and the optical centres of two cameras;

FIG. 8 illustrates the way in which the 3D coordinates of a pixel are reconstructed;

FIG. 9 represents an image corresponding to an actual result of the implementation of the method for detecting obstacles according to the invention.

### DETAILED DESCRIPTION OF THE INVENTION

In this case, a non-limiting embodiment of the invention is described, wherein the method for detecting obstacles according to the invention is used to provide assistance to the pilot of a helicopter.

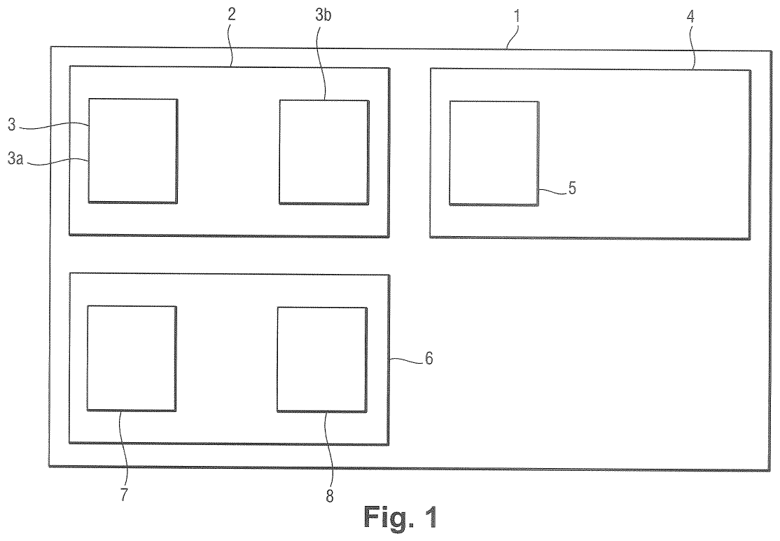

In reference to FIG. 1, the helicopter 1 first comprises a capture device 2 intended to capture images of the environment of the helicopter 1.

The capture device 2 comprises, in this case, a plurality of infrared stereo cameras 3, in this case, two stereo front cameras and two stereo side cameras. The cameras 3 comprise left cameras 3a, located on the left-larboard—of the helicopter 1 and right cameras 3b, located on the right-starboard—of the helicopter 1.

The optical sensors of the cameras 3 are wide-field sensors (for example, 180° class, with 80° of visual range per individual camera). The optical sensors are, for example, of the thermodetector type using microbolometer technology, or of the photodetector type, using a silicon-based technology.

The cameras 3 operate, in this case, in the Long Wave InfraRed (LWIR) range. The method for detecting obstacles according to the invention can therefore be used and is effective in the day, as it is at night.

The helicopter 1 also comprises an inertial unit 4 integrating an inertial measuring unit 5 (IMU) and making it possible to estimate the orientation, the position and the speed of the helicopter 1. The IMU 5 integrates navigation sensors comprising, as a minimum, three accelerometers and three gyrometers or gyroscopes.

The helicopter 1 in addition comprises a processing unit 6 comprising at least one processing component 7 which is adapted to execute instructions of a program to implement the method for detecting obstacles according to the invention. The program is stored in a memory 8 of the processing unit 6. The processing component 7 is, for example, a conventional processor, a graphics processor (or GPU, Graphics Processor Unit), a microcontroller, a DSP (Digital Signal Processor), or a programmable logic circuit, such as an FPGA (Field Programmable Gate Array) or an ASIC (Application Specific Integrated Circuit).

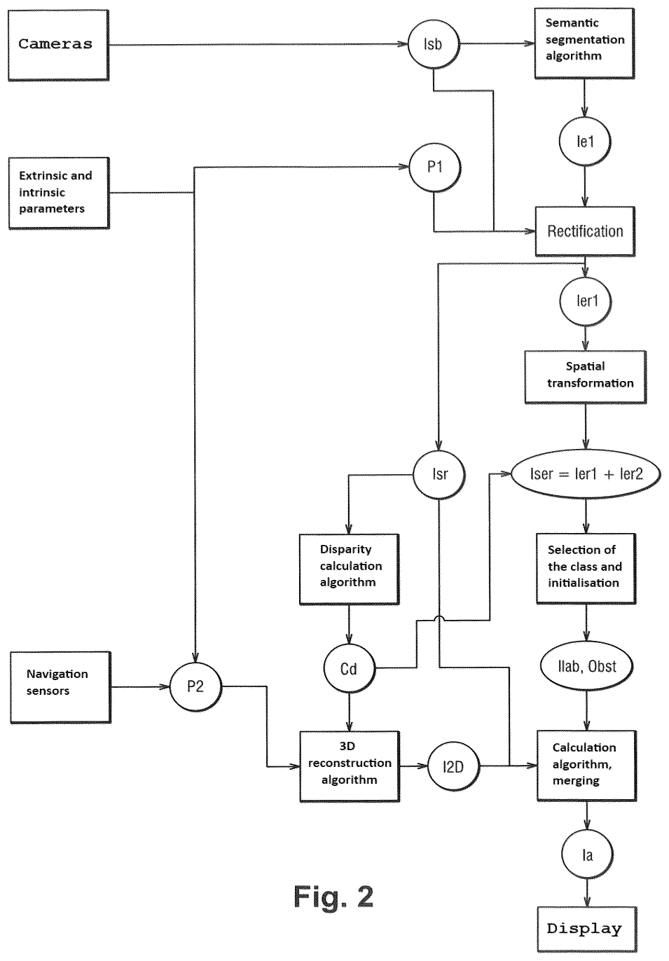

In reference to FIG. 2, the method for detecting obstacles operates as follows.

The processing unit 6 acquires, in real time, raw stereo images Isb. The raw stereo images Isb are representative of the environment of the helicopter 1 and are produced by the cameras 3 of the capture device 2. The raw stereo images Isb comprising a raw left image and a raw right image.

The processing unit 6 thus implements a deep learning-type semantic segmentation algorithm, which uses a neural network adapted to image segmentation.

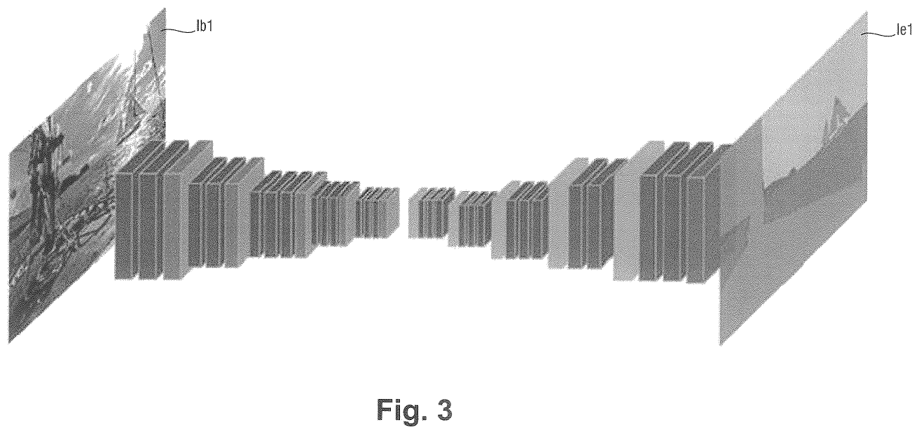

In reference to FIG. 3, the implementation of the semantic segmentation algorithm makes it possible to produce a first segmented image Ie1 from a first raw image Ib1, the first raw image Ib1 being the raw left image or the raw right image. In this case, for example, the first raw image Ib1 is the raw left image.

The neural network is, for example, a U-Net network, an HRNet (High-Resolution Network) network, or an HRNet+OCR network (OCR means Object-Contextual Representation).

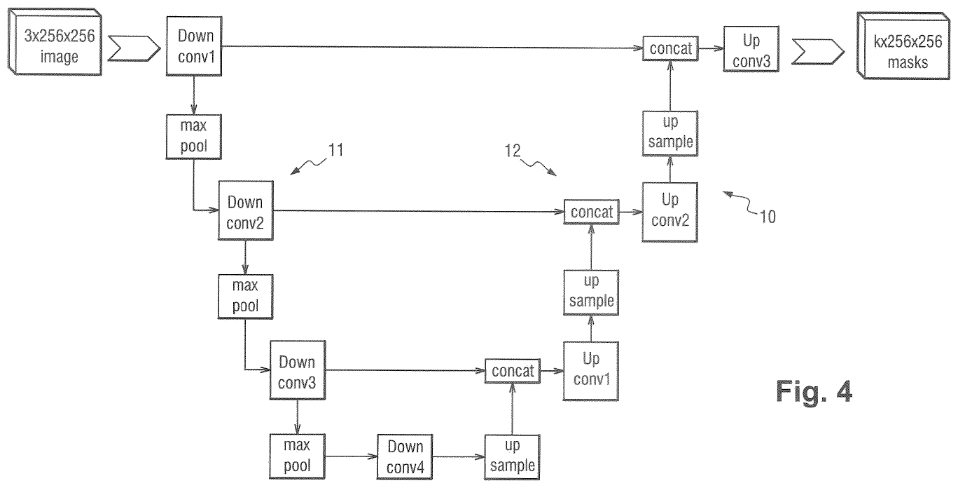

The U-Net network 10, an example of which can be seen in FIG. 4, is a convolutional neural network, which comprises an encoder part 11 and a decoder part 12. The network 10 comprises a network block which processes the response of the image to smaller and smaller successive scales (encoder part), then a network block which processes the response of the image to larger and larger successive scales (decoder part), before achieving a semantic segmentation.

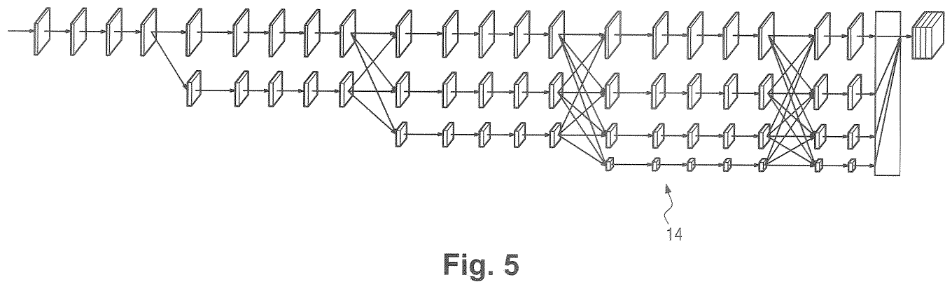

The HRNet network 14, an example of which can be seen in FIG. 5, is characterised by the fact of processing the image at different scales, at the same time.

The HRNet+OCR network is the sum of two networks. The OCR network is characterised by the use of an attention mechanism, which consists of measuring correlations between the channels and the pixels constituting the last blocks of the network.

The semantic segmentation algorithm has been instructed beforehand, by using a previously-established database. The weights associated with the neurones are calculated from the database during an instruction process.

The database is an annotated database; also, for such learning, supervised learning on tagged data is referred to. The obstacles have been annotated by hand.

This database comprises both images coming from actual flights (acquisition flights) and masks. The images come from sequences produced over several hundred hours of flight.

The images are infrared images.

Each pixels of the images of the database is encoded to select a particular class from among a plurality of classes.

The annotated classes have been selected to represent two types of object: objects forming obstacles and objects constituting the environment. The objects constituting the environment aim to be identified in order to facilitate the discrimination of the obstacles in different environments. The discrimination of the environment also makes it possible to identify, in the image, potential landing zones and the horizon line.

The plurality of classes comprises, in this case, seven classes, which respectively select the sky, the ground, vegetation, cables, pylons, and the other types of obstacles of human clutter (other than cables and pylons). Other classes can be defined, for example, a class selecting humans and another class selecting vehicles.

The definition of classes is adapted to the application in which the invention is implemented. The chosen classes, in this case, make it possible to differentiate types of obstacles, which are specifically dangerous for a helicopter, like cables, and also enable the detection of obstacles, which can constitute crossing points, like pylons. A pylon is an indicator of the flight altitude to be preserved to avoid any collision with cables.

The database has been created so as to avoid overlapping visual information in the different classes. Therefore, certain objects appear like other objects of a different type, but having a close visual appearance.

For example, a street light is not an electric pylon, but its visual appearance is such that it can easily appear like it.

In addition, limits are set on the size of the objects, such that objects comprising a low number of pixels are not annotated. For example, a house having a size of four pixels is not annotated.

Advantageously, only one part of the base is used for learning, while another part is used to verify the results obtained and thus avoid an “Overfitting” of the network.

More specifically, the base comprises three parts: an “instruction” part, which is directly used in the backpropagation of gradients to iteratively formulate the weights of the neurones, a “validation” part which serves to monitor the performance of the neural network on data not seen during the instruction, and makes it possible to adjust the instruction hyper-parameter, and finally, a “test” part which is only known by the client entity/organisation. The test part can be used by the client entity to measure the performance with their own data.

Once the network has been instructed, an input image is applied to the network input, and typically, an inference block is obtained at the network output. This inference block is a matrix of dimension C×H×W, where C is the number of classes, H is the height of the image at the input and W is the width of the image at the input.

This inference block is the response of the input image to the neural network.

Then, each pixel is standardised by using a Softmax-type function. This conveys the response of the image in a matrix where the sum of the C elements of the dimension corresponding to the classes and associated with each particular pixel is equal to around 1. This is only a standardised response and not a probability. This standardised value makes it possible to have a visibility on the preponderance of a class with respect to the others, simply from its value taken in isolation.

To obtain the class of a pixel, the coordinate of the element is extracted, the response to the system of which is the highest of the line corresponding to the classes and associated with said pixel.

Thus, a class is associated with each pixel of the first raw image. Then, a colour can also be associated with each class.

It is noted that the use of a database comprising images produced in the infrared range, to instruct the semantic segmentation algorithm, makes it possible to very significantly improve the effectiveness of said operating algorithm to perform the detection and the recognition of obstacles on infrared images. Indeed, the instruction of such an algorithm with a database constituted of visible images or of synthetic images does not guarantee its operation in another range. The change of range from visible into infrared is indeed a difficult operation, and not very well understood today.

The processing unit 6 thus rectifies the raw stereo images Isb to obtain rectified stereo images Isr (pair of rectified images), and the first segmented image Ie1 to obtain a first rectified segmented image Ier1.

The rectification comprises a distortion correction and uses first parameters P1 comprising extrinsic and intrinsic parameters of the cameras 3.

The extrinsic and intrinsic parameters have been produced during calibration operations performed in the factory.

The extrinsic parameters comprise levels of rolls, pitching and yaw of the cameras 3 with respect to the “system” (system associated with the helicopter 1).

The intrinsic parameters comprise the focal distance of each camera 3, the distance between the cameras 3, of the distortion parameters, the size of each pixel, the binocular distance.

The rectification makes it possible to obtain the rectified stereo images Isr and the first rectified segmented image Ier1, the epipolar lines of which are horizontal.

The processing unit 6 thus implements a disparity calculation algorithm between the rectified stereo images Isr, to obtain a disparity map Cd.

The disparity is a measurement used to estimate the depth and therefore to reconstruct a three-dimensional view of the environment of the helicopter 1.

The disparity map Cd is a digital image (disparity image) which contains information on the correspondences of the points of one same scene taken with two different viewing angles, in this case, with the left cameras 3a and with the right camera 3b of the capture device 2. The images of disparities evolve in real time.

The processing unit 6 thus verifies the disparity value of each pair of homologous pixels comprising a left pixel of a left image (produced by the left cameras 3a of the capture device 2) and a right pixel of a right image (produced by the right cameras 3b of the capture device 2).

The verification of the disparity makes it possible, in particular, to remove false pairings caused by occultations.

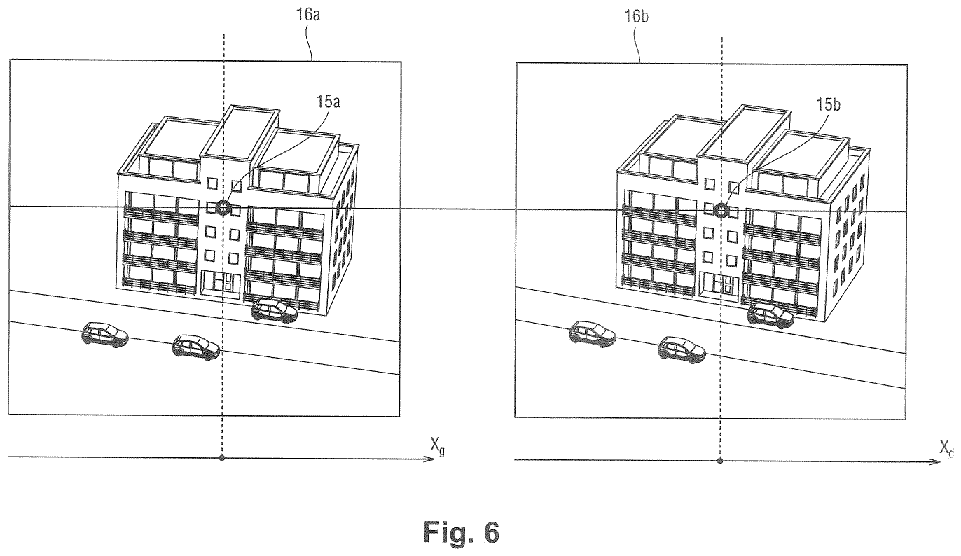

In reference to FIG. 6, the verification of the validity of the disparity of a pair of homologous pixels is, in this case, implemented as follows.

The pair of homologous pixels comprises a left pixel 15a and a right pixel 15b, which belong respectively to a left image 16a and to a right image 16b (and which have one same y coordinate vertically).

With the left image 16a as reference, the coordinate of the right pixel 15b gives:

$${x}_{d} = {x}_{g} - {disp}_{g} ( {x}_{g} , y ) ,$$

disp_{g} being the estimated disparity by taking the left image 16a as reference.

With the right image 16b as reference, the coordinate of the left pixel 15a gives:

$${x}_{g} = {x}_{d} + {disp}_{d} ( {x}_{d} , y ) ,$$

disp_{d} being the estimated disparity by taking the right image 16b as reference.

The estimated disparities must verify:

$${disp}_{g} ( {x}_{g} , y ) = {disp}_{d} ( {x}_{g} - {disp}_{g} ( {x}_{g} , y ) , y ) ,$$

$${disp}_{d} ( {x}_{d} , y ) = {disp}_{g} ( {x}_{d} - {disp}_{d} ( {x}_{d} , y ) , y ) .$$

Other mechanisms could be used to verify the disparity and, in particular, a post-accumulation mechanism of the disparity images. This mechanism consists of projecting the disparity images passed over the current disparity image, in order to temporarily filter the disparity value of each pixel. To do this, the disparity values are used, the navigation information coming from inertial units and GPS information, the intrinsic parameters and the extrinsic parameters of the cameras. Such a post-accumulation makes it possible to reduce the disparity errors. Several verification mechanisms could be used in a combined manner.

The detection method thus implements a spatial transformation of the first rectified segmented image Ier1, by using the disparity map, to produce a second rectified segmented image Ier2. The second rectified segmented image Ier2 corresponds to the side opposite that of the first raw image (i.e. in this case, on the right side). Thus, rectified segmented stereo images Iser are produced. The spatial transformation is, in this case, a spatial interpolation.

The disparity map Cd is therefore used to transpose the first rectified segmented image Ier1 (in this case, the image on the left side) onto the eye of the other side (in this case, right eye), by spatial interpolation of Ier1 with the movement field induced by the disparity, to produce a second rectified segmented image Ier2 (in this case, the image on the right side) and thus constitute a segmented stereo pair Iser from one single segmentation inference on the left eye (calculation gain).

The rectified stereo images Isr and the rectified segmented stereo images Iser are then projected into a system associated with the headset of the pilot of the helicopter 1.

The processing unit 6 thus implements a three-dimensional reconstruction algorithm, using the disparity map Cd, to produce three-dimensional coordinates for each pixel of the raw stereo images Isb (original images).

The three-dimensional reconstruction algorithm uses second parameters P2 comprising the extrinsic and intrinsic parameters of the cameras 3, as well as navigation data produced by the navigation sensors and the IMU 5.

The navigation data comprise levels of rolls, pitching and yaw of the helicopter 1 in a local geographic system, as well as levels of rolls, pitching and yaw of the cameras 3 with respect to the helicopter 1, as well as a latitude and a longitude of the helicopter 1.

The three-dimensional reconstruction uses the principles below.

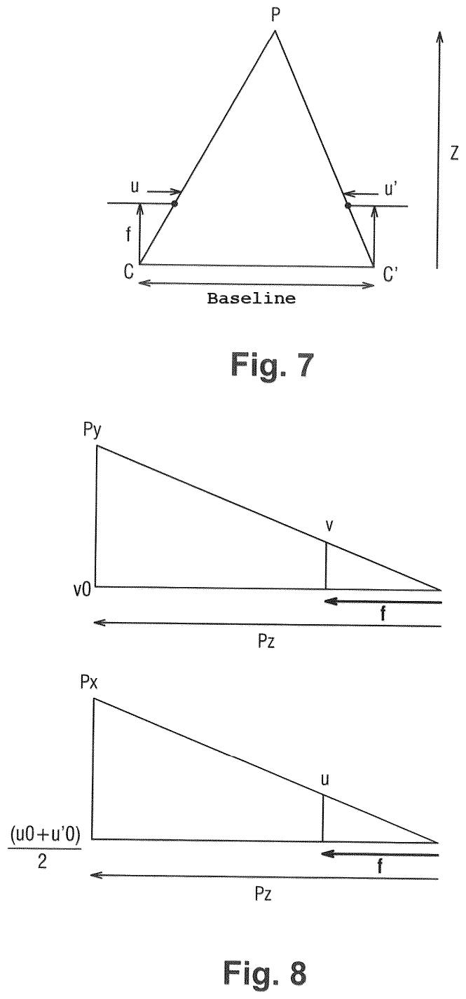

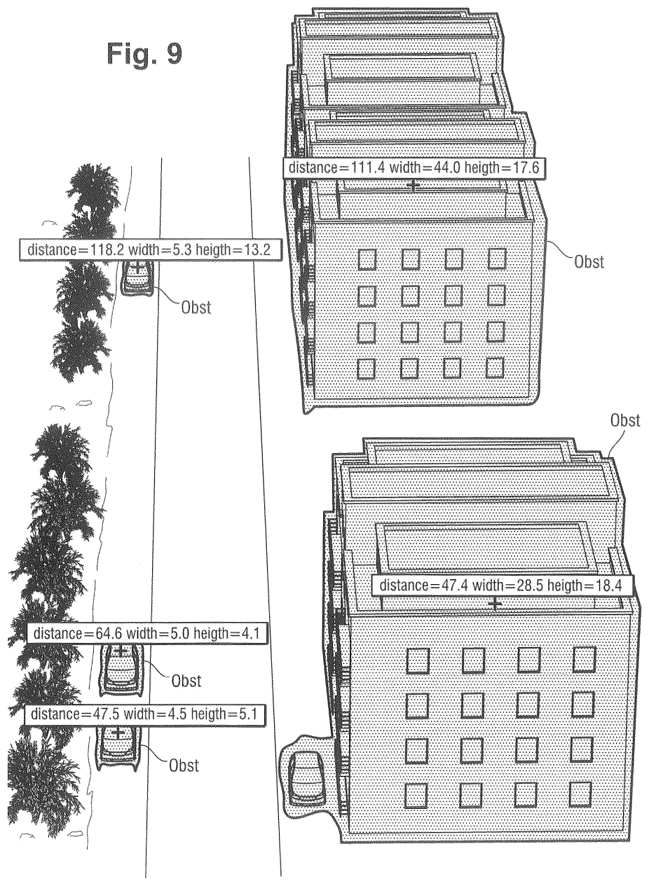

In FIG. 7, it is seen that, for an object point P in a Cartesian coordinate system, an image point of coordinates (u, v) can be found in a system associated with a left camera and an image point of coordinates (u′, v) in a system associated with a right camera (for rectified cameras and a visible object in the field of vision of the two cameras). Each pixel in the camera of optical centre C has coordinates (u, v) and in the camera of centre C′ has coordinates (u′, v′).

The distance (u-u′) is called disparity d.

Z is the distance from the object point to the optical sensors of the two cameras (Z=Pz).

C-C′ is the baseline B and corresponds to the distance between the optical centres of the cameras C and C′.

f (focal distance) is the distance from the optical centres to the pixel matrices.

To find the link between disparity and depth, Thales's theorem is applied.

The following is thus obtained:

$$\frac{u - {u}^{′}}{C - {C}^{′}} = \frac{f}{Z} \qquad ( 1 )$$

This equation gives:

$$Z = \frac{( C - {C}^{′} ) f}{u - {u}^{′}} \qquad ( 2 )$$

By replacing C−C′ and u−u′ with respectively B and d, the following is obtained:

$$Z = \frac{Bf}{d} \qquad ( 3 )$$

In this case, f and d are expressed in metres, but these magnitudes are converted into pixels in reality, which does not change the equation (3). To express the disparity d in pixels, it is sufficient to substitute d with d*pitch in the equation above, pitch being the size in metres of the pixel.

The reasoning can be generalised and, from the equation (3), the coordinates Px and Py of the object point P are found. The centres of the pixel systems of the cameras have, for coordinates (u0, v0) and (u′0, v′0).

The following is given:

$$\frac{v - v 0}{Py} = \frac{f}{Pz} and \qquad ( 4 )$$

$$\frac{u - \frac{( u 0 + {u}^{′} 0 )}{2}}{Px} = \frac{f}{Pz} \qquad ( 5 )$$

By injecting the result from the equation (3) into the equations (4) and (5) instead of Pz, the following is obtained:

$$P y = \frac{B ( v - v 0 )}{d} \qquad ( 6 )$$

$$Px = \frac{B ( u - \frac{( u 0 + {u}^{′} 0 )}{2} )}{d} \qquad ( 7 )$$

For a given disparity map, the coordinates [Px, Py, Pz] of each pixel are therefore calculated, having a valid disparity by using the equations (3), (6) and (7).

For each pixel (u, v), a vector [u, v, d, 1] is created.

Thus, a matrix Q is created, which is of the following form to calculate the non-homogeneous Cartesian coordinates of each pixel per matrix multiplication:

$$Q = [ \begin{matrix}1 & 0 & 0 & - Cx \\ 0 & 1 & 0 & - Cy \\ 0 & 0 & 0 & f \\ 0 & 0 & - 1 / Tx & ( Cx - {C}^{′} x ) / Tx\end{matrix} ] ,$$

Tx being the baseline, f being the focal length, and (Cx, Cy), (Cx′, Cy′) being the coordinates of the optical centres of the cameras in pixels.

The processing unit 6 thus produces three-dimensional coordinates of pixels of a three-dimensional reconstructed image representative of the environment of the helicopter 1. The three-dimensional coordinates of the pixels are defined in a local geographic system associated with the helicopter 1 and yaw-corrected (thanks to the navigation data).

The three-dimensional coordinates of the pixels are thus projected so as to produce two-dimensional images I2D of the three-dimensional coordinates of each reconstructed pixel.

At the same time, the processing unit 6 analyses the rectified segmented stereo images Iser and selects the class of each pixel according to its response to the semantic segmentation algorithm.

The processing unit 6 thus performs an initialisation of each obstacle and produces a list of predefined instances of obstacles Obst present in the environment of the helicopter 1 from rectified segmented stereo images Iser.

The processing unit 6 determines that a group of pixels of a rectified segmented stereo image Iser forms a predefined obstacle instance Obst when said pixels are connected together. In this case, it is considered that two pixels are connected together, if one of the two pixels belongs to the vicinity of the other, and if the two pixels belong to one same class.

The vicinity of a particular pixel is defined, in this case, as comprising eight “primary” neighbouring pixels around said particular pixel.

The processing unit 6 allocates a specific identifier for each group of pixels which are neighbouring one another, in order to be able to classify each obstacle.

The processing unit 6 thus produces a flow comprising the tagged images Ilab, as well as the coordinates of all the predefined instances of obstacles Obst.

The processing unit 6 thus integrates, by using the three-dimensional coordinates, the predefined instances of obstacles Obst in intermediate obtained from rectified stereo images Isr, to produce augmented images Ia intended to provide assistance to the piloting of the helicopter 1.

The intermediate images are, in this case, the rectified stereo images Isr themselves, i.e. that the predefined instances of obstacles Obst are integrated in the rectified stereo images Isr to produce the augmented images Ia.

For that, the processing unit 6 first implements a calculation algorithm to extract overall characteristics on the size of each predefined obstacle instance in height and width, by measuring the standard deviation of the 3D positions of the pixels composing said predefined obstacle instance.

The calculation algorithm thus acquires the coordinates of each predefined obstacle instance Obst and uses the two-dimensional images I2D of the three-dimensional coordinates of the reconstructed pixels to calculate, for each predefined obstacle instance Obst, the average distance between said predefined obstacle instance and the helicopter, as well as the width and the height of said predefined obstacle instance.

The processing unit 6 indeeds knows the pixels belonging to one same obstacle, thanks to the segmentation, the 3D reconstruction of each pixel having a valid disparity, and therefore deduce the characteristics from this in the local geographic system centred on the helicopter 1 and yaw-corrected.

Measuring physical characteristics of the obstacles makes it possible to adjust the flight path according to data.

The processing unit 6 implements a merging algorithm to merge the predefined instances of obstacles Obst in the rectified stereo images Isr.

For each predefined obstacle instance Obst, the merging is done by the inlaying of a cross on a barycentre of said predefined obstacle instance, with, in addition, information on its geometric characteristics. The pixels belonging to a predefined obstacle instance are highlighted by locally increasing the intensity of each pixel of the instance, or by inserting a false colour. This false colour can moreover correspond to a type of obstacle.

The processing unit 6 thus produces the augmented images Ia (in this case, stereo images).

The augmented images Ia are thus projected onto the visor of the pilot's headset. The headset is a stereoscopic headset. The augmented images are projected into the two eyes of the headset so as to obtain a stereoscopic effect.

The processing unit 6 performs an extraction of the pinhole projection (system where there is no deformation of the 3D world), corresponding to the field of vision of the pilot and to the orientation of their headset.

Naturally, the invention is not limited to the embodiment described, but includes any variant entering into the field of the invention such as defined by the claims.

In the detection method described in this case, the segmentation algorithm is implemented on one single raw image (left or right) called “first raw image” corresponding to one single eye. The disparity map is then used to project, via a spatial transformation, the segmentation in the unsegmented eye.

It would however be possible to segment the two raw, left and right images. In this case, in FIG. 2, the spatial transformation step is not carried out and the rectified segmented stereo images Iser are obtained directly exiting from the rectification step.

The segmentation on one single image enables calculation time to be saved.

The invention is not necessarily implemented to provide help to the piloting of a helicopter, but can be used in any type of vehicle, with or without a pilot: aircraft, land vehicle, drone, any type of robot (travelling on the ground, in the air), etc. Augmented images can be used to perform an autonomous navigation.

Intermediate images, wherein the predefined instances of obstacles are integrated, are not necessarily the rectified stereo images Isr, but could be other images, and for example, three-dimensional images.

The method for detecting obstacles according to the invention is not necessarily implemented in one single processing unit integrated in a vehicle, but can be implemented in one or more processing units, among which at least one can be located remotely from the vehicle (and, for example, in a base of which the vehicle has left, in another vehicle, in a Cloud server, etc.).

1. A method for detecting obstacles, implemented in at least one processing unit and comprising the steps of:
acquiring raw stereo images, representative of an environment of a vehicle and produced by stereo cameras, the raw stereo images comprising a raw left image and a raw right image;
implementing a semantic segmentation algorithm to produce a first segmented image from a first raw image, the first raw image being the raw left image or the raw right image;
rectifying the raw stereo images to obtain rectified stereo images, and the first segmented image to obtain a first rectified segmented image;
implementing a disparity calculation algorithm between the rectified stereo images, to produce a disparity map;
implementing a spatial transformation of the first rectified segmented image, by using the disparity map, to produce a second rectified segmented image, corresponding to the side opposite that of the first raw image, and thus produce rectified segmented stereo images;
producing a list of predefined instances of obstacles present in the vehicle's environment from rectified segmented stereo images;
implementing a three-dimensional reconstruction algorithm, using the disparity map, to produce three-dimensional coordinates for each pixel of the raw stereo images;
integrating, by using the three-dimensional coordinates, the predefined instances of obstacles in intermediate images obtained from rectified stereo images, to produce augmented images intended to provide assistance to the piloting of the vehicle.

2. The method for detecting obstacles according to claim 1, wherein the rectification step comprises a distortion correction and uses first parameters comprising extrinsic and intrinsic parameters of the stereo cameras.

3. The method for detecting obstacles according to claim 1, wherein epipolar lines of the rectified stereo images and of the rectified segmented stereo images are horizontal.

4. The method for detecting obstacles according to claim 1, further comprising the step, preceding the implementation of the disparity calculation algorithm, of projecting the rectified stereo images into a system associated with a headset of a pilot of the vehicle.

5. The method for detecting obstacles according to claim 1, wherein the three-dimensional reconstruction algorithm uses second parameters comprising extrinsic and intrinsic parameters of the stereo cameras, as well as navigation data produced by navigation sensors of an inertial measuring unit of the vehicle.

6. The method for detecting obstacles according to claim 1, wherein the three-dimensional coordinates of the reconstructed pixels are defined in a local geographic system associated with the vehicle and yaw-corrected.

7. The method for detecting obstacles according to claim 1, further comprising the step, preceding the implementation of the reconstruction algorithm, of verifying a validity of a disparity value of each pair of homologous pixels comprising a left pixel of a left image and a right pixel of a right image.

8. The method for detecting obstacles according to claim 7, wherein the verification of the validity of the disparity of the pair of homologous pixels comprises the step of verifying that:
$${disp}_{g} ( {x}_{g} , y ) = {disp}_{d} ( {x}_{g} - {disp}_{g} ( {x}_{g} , y ) , y ) and$$
$${disp}_{d} ( {x}_{d} , y ) = {disp}_{g} ( {x}_{d} - {disp}_{d} ( {x}_{d} , y ) , y )$$
disp_{g} being an estimated disparity by taking the left image as reference, disp_{d} being an estimated disparity by taking the right image as reference, x_{g} being a coordinate of the left pixel and x_{d} being a coordinate of the right pixel.

9. The method for detecting obstacles according to claim 7, wherein the verification of the validity of the disparity of the pair of homologous pixels comprises the step of implementing a post-accumulation mechanism by projecting disparity images passed over a current disparity image.

10. The method for detecting obstacles according to claim 1, comprising the step of determining that a group of pixels of a rectified segmented stereo image (Iser) forms a predefined obstacle instance when said pixels are connected together.

11. The method for detecting obstacles according to claim 10, wherein two pixels are connected together, if one of the two pixels belongs to the vicinity of the other, and if the two pixels belong to one same class.

12. The method for detecting obstacles according to claim 1, wherein the integration step comprises the steps, for each predefined obstacle instance (Obst), of determining, by using coordinates of the predefined obstacle instance and the three-dimensional coordinates of the reconstructed pixels, a distance between said predefined obstacle instance and the vehicle (1), as well as dimensions of said predefined obstacle instance.

13. The method for detecting obstacles according to claim 1, wherein the intermediate images are the rectified stereo images.

14. The method for detecting obstacles according to claim 1, wherein the integration step comprises, for each predefined obstacle instance, the step of inlaying a cross on a barycentre of said predefined obstacle instance.

15. The method for detecting obstacles according to claim 1, wherein the semantic segmentation algorithm uses a U-Net, HRNet, or HRNet+OCR neural network.

16. The method for detecting obstacles according to claim 1, wherein the stereo cameras are infrared cameras.

17. A system comprising stereo cameras and a processing unit, wherein the method for detecting obstacles according to claim 1 is implemented.

18. A vehicle comprising the system according to claim 17.

19. (canceled)

20. A non-transitory recording medium which can be read by a computer, on which a computer program comprising instructions which make a processing unit of a system execute the steps of the method for detecting obstacles according to claim 1 is recorded.
